(19) United States
(12) Patent Application Publication
(10) Pub. No.: US 2012/0290368 A1
(43) Pub. Date: Nov. 15, 2012

(54) POINT-OF-SALE SYSTEM USING PREPAID/GIFT CARD NETWORK

(75) Inventor: Sung Im, Oakton, VA (US)

(73) Assignee: World Bank Services, Inc., Annandale, VA (US)

(21) Appl. No.: 13/106,572

(22) Filed: May 12, 2011

(51) Int. Cl. G06Q 20/34; G06Q 30/02

(52) U.S. Cl. 705/14.3; 705/17

(57) ABSTRACT

A method and an apparatus for operating a gift card network are disclosed. The system receives registration data from first and second merchants, each having one or more points of sale, and processes the registration data to establish membership of the merchants in a gift card network. The system then receives card issuance data from the first merchant, the card issuance data reflecting at least a unique serial number and a monetary value associated with a network gift card issued by the first merchant. The network gift card is redeemable at the first merchant or at other merchants which have established membership in the gift card network. When a transaction occurs in which the card issued by the first merchant is used at the second merchant, transaction data is received from the second merchant, the transaction data indicating that at least a portion of the monetary value of the network gift card has been redeemed at the second merchant. In response, the system applies a credit to the first merchant, the credit being equal to or derived from the value that has been redeemed at the second merchant.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The present invention relates in general to the field of gift cards, and in particular to novel systems and methods for providing networked gift cards.

2. Description of the Related Art

A gift card or prepaid card (“gift card”) is a restricted monetary equivalent or scrip that is issued by retailers or banks and is often, but not always, used as an alternative to a non-monetary gift. Gift cards may resemble a credit card or display a specific theme on a plastic card the size of a credit card. The card is identified by a specific number or code, and is usually not imprinted with or associated with an individual cardholder name. Thus, gift card usually can be used by any bearer. Gift cards are backed by an on-line system for authorization and payment and payment.

U.S. Patent Application No. 20100274659 describes a loyalty system which allows a consumer to accumulate general loyalty points from one or more merchants, then convert any desired subset of general loyalty points to loyalty dollars (or monetary equivalent) associated with a specific merchant. The system stores, for each consumer, the loyalty dollars by merchant within a remotely-accessible host database, within the magnetic stripe or within a smart card database. Upon conducting a purchase at a particular merchant, the consumer may utilize a consumer ID to facilitate access to the consumer's own loyalty dollars for the particular merchant. The loyalty dollars are then applied to the purchase transaction as a discount or rebate. The consumer may also re-load the loyalty dollars.

### SUMMARY OF THE INVENTION

The present invention in one embodiment provides a method and an apparatus for operating a gift card network. The system receives registration data from first and second merchants, each having one or more points of sale, and processes the registration data to establish membership of the merchants in a gift card network. The system then receives card issuance data from the first merchant, the card issuance data reflecting at least a unique serial number and a monetary value associated with a network gift card issued by the first merchant. The network gift card is redeemable at the first merchant or at other merchants which have established membership in the gift card network. When a transaction occurs in which the card issued by the first merchant is used at the second merchant, transaction data is received from the second merchant, the transaction data indicating that at least a portion of the monetary value of the network gift card has been redeemed at the second merchant. In response to receiving the transaction data from the second merchant, the system applies a credit to the first merchant, the credit being equal to or derived from the value that has been redeemed at the second merchant.

The network gift card is advantageous to customers and merchants in that it can be redeemed at different issuers which are members of the network. The network can be a small association, retailers in a city, county, state or so on. The system can be implemented by a third party without storing or managing account information of customers of the member merchants. Because the network gift card is a bearer cash card, it is flexible and can be used as cash at member merchants. The network gift card can be issued to third party, as a gift card or as a charity card. The network gift card system does not require harmonization of loyalty programs. Each merchant can monetize as see fits, and can add value as cash to the same card. Furthermore, various merchants can add value to the same card.

In a further embodiment, the invention provides a system and method for loading a monetary value to a gift card using loyalty points. Scanned gift card data is received at a point-of-sale station, the scanned gift card data including at least a unique serial number associated with a gift card. An identification of a customer purchasing or reloading the gift card is also received. The identification of the customer is used to perform a lookup to determine a dollar value corresponding to a number of loyalty points available in a customer's loyalty points account. The system authorizes the point-of-sale station to load said dollar value onto said gift card, and may then send transaction data to a loyalty points system indicating the number of points to be subtracted from the customer's loyalty points account.

### BRIEF DESCRIPTION OF THE DRAWINGS

The above and/or other aspects and advantages of the present general inventive concept will become apparent and more readily appreciated from the following description of the embodiments, taken in conjunction with the accompanying drawings of which:

FIG. 1 is a high-level block diagram illustrating the overall process flow according to an embodiment of a network gift card network system;

FIG. 2 is a high-level block diagram illustrating gift card issuance and reloading using loyalty points according to an embodiment of the invention;

FIG. 3 is a detailed block diagram illustrating a reloadable prepaid/gift card transaction flow according to an embodiment of the invention.

### DETAILED DESCRIPTION OF THE PREFERRED EMBODIMENT

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

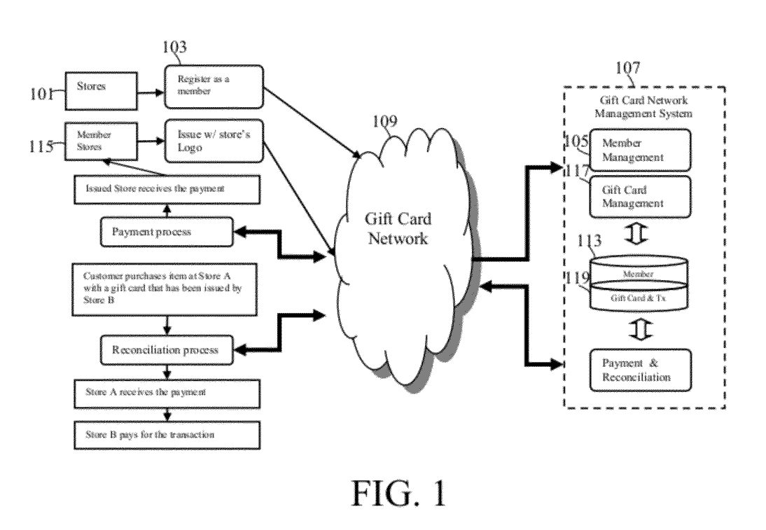

FIG. 1 is a high-level diagram illustrating the process flow according to an embodiment of a network gift card system. First, a store 101 registers in the gift card network system as a member 103. This registration process may be driven by an interactive web site serving a secure web interface from a member management module 105 running on a computer as part of the gift card network management system 107, may be driven by code running on point-of sale equipment, may be performed manually, or via other computer-driven process. In an embodiment, the registration data generated by the registration process is transmitted via the gift card network 109 to a member management module 105, which stores the registration data in a member database 113. Once the store 101 has registered in the gift card network system, it can begin issuing network gift cards.

Next, an issuing store 115 issues a network gift card to a customer. The network gift card preferably includes the issuing store's store logo, but also includes a gift card network logo or other indicia indicating that it can be redeemed at other stores which are members of the gift card network.

The issuing store 115 receives payment from a customer when the customer purchases the card. The transaction may be processed via a point-of-sale station programmed to upload the card data, including a unique serial number, issuing store, monetary value of the network gift card, and other identifying data, to the gift card network management system 107 via the gift card network 109. A gift card management module 117 running on a computer in the gift card network management system 107 checks the value associated with the network gift card in its gift card and transaction database 119, reports back the value on the card to the point-of-sale station processing the transaction, and saves the transaction in the gift card and transaction database 119. The gift card and transaction database 119 may be integrated with the member database 113. The gift card management module 117 then decreases the monetary value of the network gift card, as stored in the gift card and transaction database 119, in the amount that has been redeemed by the customer.

For cases in which the customer purchases an item at Store A with a gift card that has been issued by Store B, the gift card network system provides a reconciliation process by which the system collects the redeemed value from the issuing store and issues a credit to the store where the customer used the card. The credit may be in the form of an internal credit reflected in the gift card network's gift card and transaction database 119, may be a credit transfer to a third party processing company, may be an electronic funds transfer, or other form of electronic credit.

A customer holding a gift card may purchase additional value in any store 115 that is a member of the gift card network. When additional value is purchased, the gift card network system adds monetary value to the card by updating the gift card and transaction database 119. A magnetic stripe or other form of storage on the card itself may also be updated to reflect the increased value. When the gift card becomes expired or is reported lost, the gift card network terminates the card in its records by updating the gift card and transaction database 119.

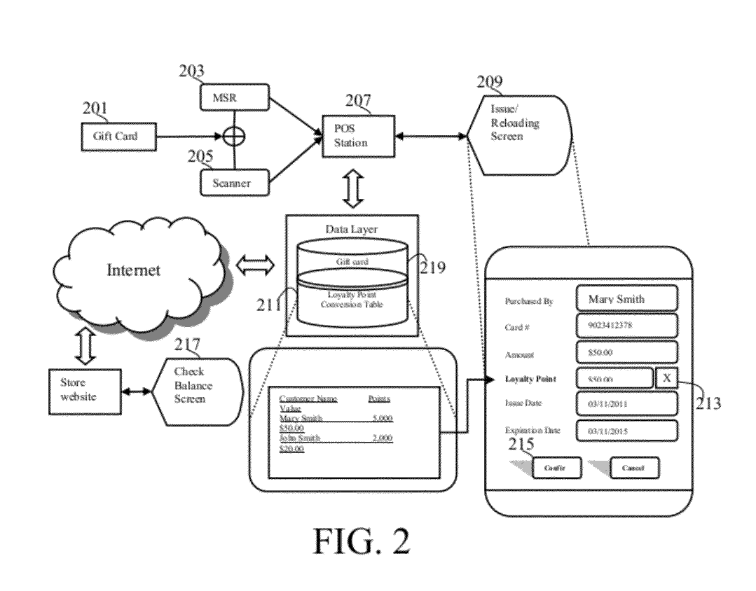

FIG. 2 shows a high-level process flow illustrating a point-of-sale embodiment wherein gift cards 201 are issued and/or reloaded using loyalty points. This embodiment provides a gift card 201 for integration with a store's loyalty point system at its point of sale. The gift card 201, like other stored-value cards, can be “recharged” or “reloaded” by payment on the presented card at the point of sale. In the point-of-sale system according to the present embodiment, gift cards 201 can be issued, reloaded, and their balances checked. A member store's reward/loyalty points can be converted into monetary value and the cash value can be loaded into the gift cards by swiping a card 201 past a magnetic stripe reader (MSR) 203 or by scanning it using a barcode scanner or other point-of-sale scanner 205 which is connected to the system.

The workflow for issuing a gift card in accordance with the present embodiment is as follows. First, a cashier or the customer presents a blank gift card 201 at the point of sale for purchasing by customer. The cashier swipes the blank gift card past the magnetic stripe reader 203 or scans a barcode (or other indicia) on the gift card. The cashier enters the customer's name into the point-of-sale station 207. The point-of-sale station 207 displays the card's unique serial number in a gift card issue/reloading screen 209 in the point-of-sale-station 207. The cashier enters into the point-of-sale station 207 an initial value to be added to the gift card 201. The point-of-sale station performs a lookup in the store's loyalty system database to determine the number of loyalty points existing in the customer's account. The point-of-sale station 207 uses a loyalty point conversion table 211 to convert the customer's points to a monetary value.

If the customer indicates that they would like to use their loyalty points to cover the value being added to the gift card, the cashier then checks a check box 213 on the issue/reloading screen 209. The cashier presses a “Confirm” button 215 to issue the gift card, and the point-of-sale station 207 then saves the issued card information to the gift card database 219 and updates the store's loyalty point system to reflect the appropriate reduction in points. The customer may thereafter use the gift card at the store where they purchased the gift card.

The process for reloading a gift card in accordance with the loyalty points embodiment of FIG. 2 will now be described. When a customer presents a gift card 201 for reloading at a point-of-sale station 207, the cashier swipes the card past a magnetic stripe reader 203, barcode scanner 205, or other indicia reading device. The cashier enters the customer's name into the point-of-sale station 207. The point-of-sale station 207 displays the card number in the gift card reloading screen 209, along with any value already associated with the card 201. The cashier may then enter additional value to be added to the gift card 201. The point-of-sale station uses the loyalty point conversion table 211 to convert the points to monetary value. If the customer indicates that they would like to use their loyalty points to cover the value being added to the gift card 201, the cashier then checks a check box 213 on the issue/reloading screen. The point-of-sale station uses the loyalty point conversion table 211 to convert the customer's loyalty points to monetary value when the customer chooses to use loyalty points. A check balance screen 217 allows the customer or the cashier to check the balance of loyalty points available. The cashier presses a “Confirm” button 215 to issue the gift card, and the point-of-sale station 207 then saves the reloaded card information to the gift card database 219 and updates the store's loyalty point system to reflect the appropriate reduction in points.

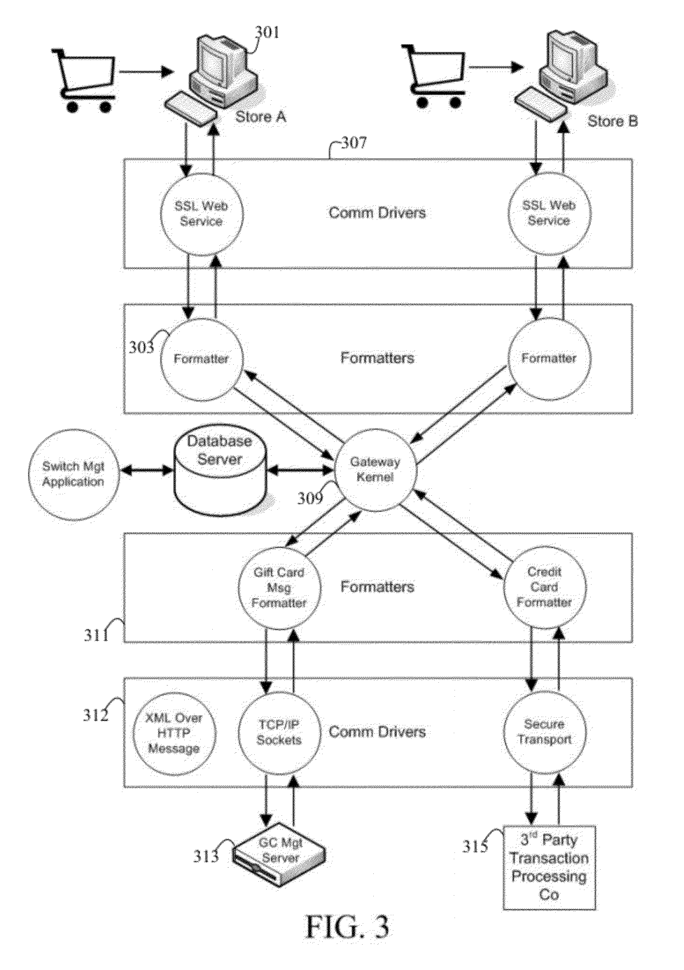

FIG. 3 shows a detailed block diagram illustrating the process flow for transactions in accordance with the first or second embodiments of the reloadable prepaid/gift card. The card sale/activation process is as follows. The customer arrives at a point-of-sale station 301 at Store A to purchase a gift card. A formatter module 303 running on a computer associated with the point of sale station receives gift card purchase data from the point-of-sale station 301 via a comm driver 307. The formatter module 303 uses the gift card purchase data to build and send a gift card purchase message to the gift card network to activate the card and set the card initial balance.

The gateway kernel 309, which may be running on a gateway server associated with the gift card network, receives the transaction message. Based on the card BIN number (PAN first 6 digits), the authorization route is established. The authorization route comprises a formatter 311 and a comm driver 312.

Based on the authorization route, the message is sent to the gift card management server 313, and the gift card management server 313 sends a response message to the gateway. The gateway receives the response, matches the origination transaction, and routes the message back to the originating POS station 301.

With continued reference to FIG. 3, in an embodiment, the process flow of card usage and authorization requests will now be described. A customer arrives at a point of sale station 301 associated with Store A to purchase products/services with a gift card. A formatter 303 running on a computer associated with the point of sale receives purchase data from the point-of-sale station via a comm driver 307, and builds and sends a standard authorization request message. The gateway receives the transaction message and, based on the card BIN number (PAN first 6 digits), the authorization route is established.

Based on the authorization route, the message is sent to the prepaid/gift card management server. The prepaid/gift card mgmt server 313 sends an authorize/decline response message to the gateway. The gateway receives the response, matches the origination transaction and routes the message back to the originating POS station 301.

With continued reference to FIG. 3, an example of a batch close and settlement process in accordance with an embodiment of the invention will now be described. The POS device must first build a close batch record to the Host for settlement to occur. Since the settlement is conducted differently for gift cards than for debit/credit transactions, this will be a different batch close message to be routed to the gift card management server—independent from the settlement process conducted by a third party credit card transaction processor 315 (e.g., First Data). The BATCH AMOUNT field will usually consist of an unsigned value, entered without a plus (+) or minus (−) sign. However, when the amount of returns exceeds the amount of purchases, then a leading minus sign is necessary to indicate a negative amount. Prepaid card purchase or reload is represented by negative amounts, and purchases with prepaid/gift cards are represented by positive amounts.

The gateway kernel 309 then routes then the batch close message to the gift card management server 313, which sends the close batch response message to the gateway. The gateway receives the response, matches the origination close transaction and routes the message back to the originating point-of-sale station 301.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

Although embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method for operating a gift card network, comprising:
receiving first registration data from a first merchant having one or more points of sale and processing said first registration data to establish membership of said first merchant in a gift card network;
receiving second registration data from a second merchant having one or more second points of sale and processing said second registration data to establish membership of said second merchant in said gift card network;
receiving card issuance data from said first merchant, said card issuance data reflecting at least a unique serial number and a monetary value associated with a network gift card issued by said first merchant, the network gift card being redeemable at the first merchant or at other merchants which have established membership in the gift card network;
receiving a transaction data from said second merchant, said transaction data indicating that at least a portion of said monetary value of said network gift card has been redeemed at said second merchant; and,
in response to receiving said transaction data from said second merchant, applying a credit to said first merchant, said credit applied to said first merchant being equal to or derived from said value that has been redeemed at said second merchant.

2. A method of loading a monetary value to a gift card, comprising:
receiving scanned gift card data at a point-of-sale station, said scanned gift card data including at least a unique serial number associated with a gift card;
receiving an identification of a customer purchasing or reloading said gift card;
using said identification of said customer to perform a lookup to determine a dollar value corresponding to a number of loyalty points available in a customer's loyalty points account; and,
authorizing said point-of-sale station to load said dollar value onto said gift card.

3. The method of claim 2, further comprising sending transaction data to a loyalty points system indicating the number of points to be subtracted from said customer's loyalty points account.

4. A Point-Of-Sale (POS) reward system, comprising:
a POS device associated with a merchant system configured to process a sale transaction at a point-of-sale, to process a reward associated with the sale transaction, and to monetize the reward,
wherein the POS device monetizes the reward at the point-of-sale as at least one of a cash-card issued through the POS device and a balance increase to a pre-existing cash-card.

5. The POS reward system of claim 4, wherein the cash-card is issued to bearer and readily transferable.

6. The POS reward system of claim 4, wherein the sale transaction comprises at least one of a purchase, sale, exchange, and return of merchandise.

7. The POS reward system of claim 4, wherein the merchant system is part of a specified network and the cash-card is usable through other merchant systems within the specified network.

8. The POS reward system of claim 4, wherein the merchant system is part of a specified network and the cash-card is usable through other POS devices within the specified network.

9. The POS reward system of claim 8, wherein the specified network is an open network and the cash-card is usable with any merchant system within the specified network.

10. The POS reward system of claim 8, wherein the specified network is a closed network and the cash-card is usable only with a predetermined group of merchant systems within the specified network.

11. The POS reward system of claim 4, wherein the monetization of the reward comprises:
assessing a reward account through the POS device corresponding to the customer in the sale transaction;
determining a value of the reward associated with the sale transaction according to monetization criteria;
modifying a balance of the reward account according to the value of the reward; and
wherein the monetization of the reward comprises monetizing up to the balance of the reward account according to the monetizing criteria,
wherein, if the customer does not have a pre-existing reward account, a reward account for the customer is set up through the POS device.

12. The POS reward system of claim 11, wherein the reward account is associated with identifying information of the customer.

13. The POS reward system of claim 12, wherein the identifying information is at least one of a name, a telephone number, an address, and an email address of the customer.

14. The POS reward system of claim 11, wherein the reward account is hosted within the specified network.

15. The POS reward system of claim 11, wherein the reward account is hosted within the merchant system.

16. The POS reward system of claim 11, wherein the monetization criteria resides within the specified network and the POS device assesses the monetization criteria when processing the reward.

17. The POS reward system of claim 11, wherein the monetization criteria resides within the merchant system and the POS device assesses the monetization criteria when processing the reward.

18. The POS reward system of claim 11, wherein the monetization criteria is the same for all merchant systems within the specified network

19. The POS reward system of claim 11, wherein the monetization criteria is different for at least one merchant system within the specified network

20. The POS reward system of claim 11, wherein the reward account is managed by a third party also in charge of managing the specified network.

21. The POS reward system of claim 11, wherein the customer has online access to the reward account.

22. The POS reward system of claim 11, wherein the cash-card is associated with the reward account.

23. A Point-Of-Sale (POS) reward system, comprising:
A first POS device associated with a first merchant system to process a first sale transaction at a first point-of-sale, to process a first reward associated with the first sale transaction, and to monetize the first reward at the point of sale as at least one of a first cash-card issued through the POS device and a balance increase to a pre-existing cash-card,
wherein the first merchant system is part of a specified network and the first cash-card is usable through other POS devices within the specified network.

24. The POS reward system of claim 23, further comprising a second POS device associated with a second merchant system to process a second sale transaction at a second point-of-sale, to process a second reward associated with the second sale transaction, and to monetize the second reward at the point of sale as at least one of a second cash-card issued through the POS device and a balance increase to another pre-existing cash-card,
wherein the second merchant system is part of the specified network and the second cash-card is usable through other POS devices within the specified network.

25. The POS reward system of claim 24, wherein the another pre-existing cash-card is the first cash-card.

26. The POS reward system of claim 24, wherein the first cash-card is used during the second sale transaction, and the second reward is monetized as a balance increase to the first cash-cash.

27. The POS reward system of claim 23, wherein the monetization of the first reward comprises:
assessing a reward account through the first POS device corresponding to the customer in the first sale transaction;
determining a value of the first reward associated with the first sale transaction according to first monetization criteria;
modifying a balance of the reward account according to the value of the first reward; and
wherein the monetization of the first reward comprises monetizing up to the balance of the reward account according to the first monetization criteria,
wherein, if the customer does not have a pre-existing reward account, a reward account for the customer is set up through the first POS device.

28. The POS reward system of claim 27, wherein the monetization of the second reward comprises:
assessing a reward account through the second POS device corresponding to the customer in the second sale transaction;
determining a value of the second reward associated with the second sale transaction according to second monetization criteria;
modifying a balance of the reward account according to the value of the second reward; and
wherein the monetization of the second reward comprises monetizing up to the balance of the reward account according to the second monetizing criteria,
wherein, if the customer does not have a pre-existing reward account, a reward account for the customer is set up through the second POS device.

29. A method of monetizing a reward associated with a sale transaction at a point-of-sale, the method comprising:
processing a sale transaction at the point of sale through a POS device associated with a merchant system;
determining a reward associated with the sale transaction; and
monetizing the reward as one of a cash-card issued through the POS device and a balance increase to a pre-existing cash-card,
wherein the merchant system is part of a specified network and the cash-card is usable through other POS devices within the specified network.

30. The method of claim 29, wherein the cash-card is issued to bearer and readily transferable.

31. The method of claim 29, wherein the specified network is a closed network and the cash-card is usable only with a predetermined group of merchant systems within the specified network.

32. The method of claim 29, wherein:
the determining of the reward associated with the sale transaction comprises: assessing a reward account through the POS device corresponding to the customer in the sale transaction, determining a value of the reward associated with the sale transaction according to monetization criteria, and modifying a balance of the reward account according to the value of the reward, and
wherein the monetizing of the reward comprises monetizing up to the balance of the reward account according to the monetizing criteria,
wherein, if the customer does not have a pre-existing reward account, a reward account for the customer is set up through the POS device.

33. The method of claim 32, wherein the monetization criteria resides within the specified network and the POS device assesses the monetization criteria when processing the reward.

34. The method of claim 33, wherein the monetization criteria is the same for all merchant systems within the specified network.

35. The method of claim 33, wherein the monetization criteria is different for at least one merchant system within the specified network.
